(19) United States
(12) Patent Application Publication
(10) Pub. No.: US 2026/0340624 A1
(43) Pub. Date: Oct. 29, 2026

(54) CONTACTLESS TRANSACTION RECTIFICATION SYSTEM AND METHOD

(71) Applicant: Visa International Service Association, San Francisco, CA (US)

(72) Inventors: Esha Dutta, Leander, TX (US); Geraldine Mitchley, San Francisco, CA (US)

(73) Assignee: Visa International Service Association, San Francisco, CA (US)

(21) Appl. No.: 19/109,117

(22) PCT Filed: Sep. 18, 2023
(86) PCT No.: PCT/US2023/074498

§ 371 Date: Mar. 5, 2025

Related U.S. Application Data
(60) Provisional application No. 63/410,055, filed on Sep. 26, 2022.

(51) Int. Cl. G06Q 20/34; G06Q 20/22; G06Q 20/32; G06Q 20/40

(52) U.S. Cl. CPC G06Q 20/352; G06Q 20/223; G06Q 20/3276; G06Q 20/3278; G06Q 20/405

(57) ABSTRACT

A method is disclosed. It includes prompting, by a second user device operated by a second user, a first user to interact a portable device of the first user with the second user device in a transaction and then receiving interaction data comprising a credential or token, from the portable device in a contactless communication. The method also includes determining that the transaction cannot be completed without further interaction by the first user, and responsive to determining that the transaction cannot be completed, providing at least one alternate transaction option for the first user. The method also includes receiving, from the first user, a selection of an alternate transaction option from the at least one alternate transaction option, and processing the transaction according to the selected alternate transaction option.

### CROSS-REFERENCES TO RELATED APPLICATIONS

This application is a PCT application and claims the benefit of priority of U.S. Provisional Application No. 63/410,055, filed on Sep. 26, 2022, which is herein incorporated by reference in its entirety for all purposes.

### BACKGROUND

User devices (e.g., a mobile device) are sometimes used as a point of sale (POS) terminals for merchants. However, a contactless transaction can be rejected for a number of reasons (e.g., over transaction limit, requiring offline PIN, geographical restrictions etc.). The rejected transaction may need be restarted by a merchant or a new transaction initiated to attempt the transaction with another method. Restarting failed transactions takes additional time and effort, and consumes additional computing resources.

New and improved ways to address this problem to allow users to continue with transactions, without the need to initiate new transactions, even if initial contactless transactions cannot be successfully completed.

Embodiments of the disclosure address this problem and other problems individually and collectively.

### SUMMARY

One embodiment of the invention includes a method. The method comprises: prompting, by a second user device operated by a second user, a first user to interact a portable device of the first user with the second user device in a transaction; receiving, by the second user device, a credential or token, from the portable device in a contactless communication; determining, by the first user device, that the transaction cannot be completed without further interaction by the first user; and responsive to determining that the transaction cannot be completed, providing, by the second user device, at least one alternate transaction option for the first user; receiving, by the second user device from the first user, a selection of an alternate transaction option from the at least one alternate transaction option; and processing, by the second user device, the transaction according to the selected alternate transaction option.

Another embodiment of the invention includes a second user device comprising: a processor; and a non-transitory computer readable medium, the non-transitory computer readable medium comprising code, executable by the processor, for performing operations comprising prompting, a first user to interact a portable device of the first user with the second user device in a transaction, receiving a credential or token, from the portable device in a contactless communication, determining that the transaction cannot be completed without further interaction by the first user, responsive to determining that the transaction cannot be completed, providing at least one alternate transaction option for the first user, receiving, from the first user, a selection of an alternate transaction option from the at least one alternate transaction option, and processing the transaction according to the selected alternate transaction option.

Another embodiment of the invention includes a method comprising: receiving, by an interaction processing server from a second user device operated by a second user in a transaction between the second user and a first user, after the first user interacts a portable device with the second user device in a contactless communication, a payload comprising payload information comprising a credential or token, and transaction information; determining, by the interaction processing server, if the payload information can be used to complete the transaction; determining, by the interaction processing server that the payload information cannot be used to complete the transaction; and transmitting, by the interaction processing server, a response message to the second user device, wherein the second user device provides options for completing the transaction to the first user. In some embodiments, the options include the generation of a QR code encoding the transaction information, which can be scanned by a first user device operated by the first user to complete the transaction. In some embodiments, the options include a transmission of a link to the first user device, which can be used by the first user to complete the transaction.

These and other embodiments are described in detail below.

### BRIEF DESCRIPTION OF THE DRAWINGS

FIG. 1 illustrates a transaction processing system in an embodiment of the invention.

FIG. 2 illustrates a first user device according to an embodiment of the invention.

FIG. 3 illustrates a second user device according to one embodiment of the present invention.

FIG. 4 illustrates an interaction processing server according to one embodiment of the present invention.

FIG. 5A shows a method for conducting a successful contactless transaction with a second user device.

FIG. 5B shows a method for completing a transaction according to a first option.

FIG. 5C shows a method for completing a transaction according to a second option.

FIGS. 6A-6B illustrate data flows according to other embodiments.

FIGS. 7A-7B illustrate example user interfaces according to embodiments.

### DETAILED DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments. In some examples a user may be a resource provider, a merchant, a seller, or a service provider.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the consumer.

A “user device” may be any suitable device that a user can interact with (e.g., a payment card or mobile phone). User devices may be in any suitable form. cellular phones, PDAs, personal computers (PCs), tablet computers, and the like. In some embodiments, where a user device is a mobile device, the mobile device may include a display, a memory, a processor, a computer-readable medium, and any other suitable component.

A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as smart cars, electric cars, automobiles, and motorcycles, personal music players, hand-held specialized readers, etc. A mobile device may comprise any suitable hardware and software for performing such functions, and may also include multiple devices or components (e.g., when a device has remote access to a network by tethering to another device—i.e., using the other device as a modem—both devices taken together may be considered a single mobile device).

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, and verification values such as CVV, dCVV, CVV2, dCVV2, and CVC3 values.

A “token” may be a substitute value for a credential. A token may be a string of numbers, letters, or any other suitable characters. Examples of tokens include access tokens such as payment tokens, data that can be used to access secure systems or locations, etc.

A “payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “de-tokenization” can be a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

A “token service computer” can include a system that that services tokens. In some embodiments, a token service computer can facilitate requesting, determining (e.g., generating) and/or issuing tokens, as well as maintaining an established mapping of tokens to primary account numbers (PANs) in a repository (e.g., token vault). In some embodiments, the token service computer may establish a token assurance level for a given token to indicate the confidence level of the token to PAN binding. The token service computer may include or be in communication with a token vault where the generated tokens are stored. The token service computer may support token processing of payment transactions submitted using tokens by de-tokenizing the token to obtain the actual PAN.

A “token domain” may indicate an area and/or circumstance in which a token can be used. Examples of the token domain may include, but are not limited to, payment channels (e.g., e-commerce, physical point of sale, etc.), POS entry modes (e.g., contactless, magnetic stripe, etc.), and merchant identifiers to uniquely identify where the token can be used. A set of parameters (i.e., token domain restriction controls) may be established as part of token issuance by the token service computer that may allow for enforcing appropriate usage of the token in payment transactions. For example, the token domain restriction controls may restrict the use of the token with particular presentment modes, such as contactless or e-commerce presentment modes. In some embodiments, the token domain restriction controls may restrict the use of the token at a particular merchant that can be uniquely identified. Some exemplary token domain restriction controls may require the verification of the presence of a token cryptogram that is unique to a given transaction. In some embodiments, a token domain can be associated with a token requestor.

“Token expiry date” may refer to the expiration date/time of the token. The token expiry date may be passed among the entities of the tokenization ecosystem during transaction processing to ensure interoperability. The token expiration date may be a numeric value (e.g., a 4-digit numeric value). In some embodiments, the token expiry date can be expressed as a time duration as measured from the time of issuance.

An “authorization request message” may be a message that requests permission to conduct an interaction. For example, an authorization request message may include an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

A “portable device” can be any suitable device that is portable. Examples of portable devices include mobile phones, wearable devices, fobs, etc. In some cases, a portable device can be a payment device.

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. A hardware object can relate to circuitry (e.g., permanent voltage values), and a software object can relate to non-permanent data stored on a device. A payment device may be associated with a value such as a monetary value, a discount, or store credit, and a payment device may be associated with an entity such as a bank, a merchant, a payment processing network, or a person. A payment device may be used to make a payment transaction. Suitable payment devices can be hand-held and compact so that they can fit into a user's wallet and/or pocket (e.g., pocket-sized). Example payment devices may include smart cards, magnetic stripe cards, keychain devices (such as the Speedpass™ commercially available from Exxon-Mobil Corp.), etc. Other examples of mobile communication devices include pagers, payment cards, security cards, access cards, smart media, transponders, and the like. If the payment device is in the form of a debit, credit, or smartcard, the payment device may also optionally have features such as magnetic stripes. Such devices can operate in either a contact or contactless mode. In some embodiments, a mobile communication device can function as a payment device (e.g., a mobile communication device can store and be able to transmit payment credentials for a transaction).

An “application” may be computer code or other data stored on a computer readable medium (e.g., memory element or secure element) that may be executable by a processor to complete a task.

Embodiments can provide a user with different options to perform a transaction when the user does not have a contactless portable device or the contactless portable device cannot be used for a transaction.

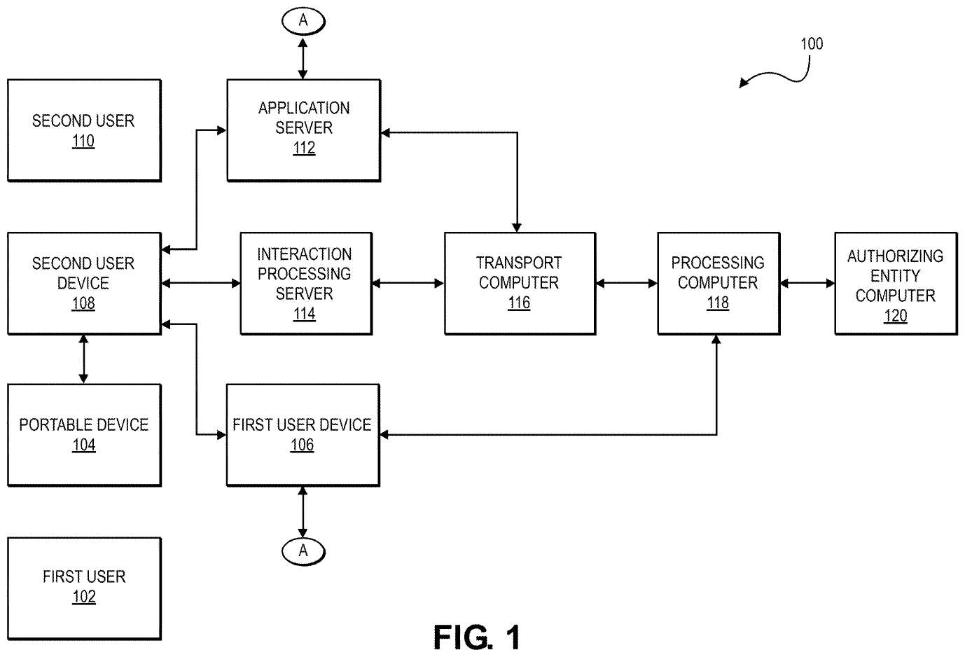

FIG. 1. illustrates a transaction processing system 100 according to embodiments of the present invention.

The transaction processing system 100 may include a first user 102 operating a portable device 104, such as a payment card and a first user device 106, such as a first mobile phone. The system 100 can include a second user 110 operating a second user device 108, which may be in communication with an application server 112. The second user device 108 can be in communication with the application server 112, an interaction processing server 114, and the first user device 106. The interaction processing server can also be in communication with a transport computer 116, a processing computer 118, and an authorizing entity computer 120. The first user device 106 can also be in communication with the processing computer 118. For simplicity of illustration, a certain number of components are shown in FIG. 1. It is understood, however, that embodiments of the invention may include more than one of each component. In addition, some embodiments of the invention may include fewer than or greater than all of the components shown in FIG. 1. Links between various components shown in FIG. 1 illustrate a possible data connection between the components.

Messages between at least the devices illustrated in FIG. 1 can be transmitted using a secure communications protocol such as, but not limited to, File Transfer Protocol (FTP); Hypertext Transfer Protocol (HTTP); Secure Hypertext Transfer Protocol (HTTPS), SSL, ISO (e.g., ISO 8583) and/or the like. Although not illustrated in FIG. 1, the various components of transaction processing system 100 may be connected through or interact with one another through a telecommunications network or through short range communication. For example, a telecommunications network may include any network that is capable of transmitting information between two entities and may be capable of using any suitable communications protocol or mechanism (e.g., a cellular network, TCP/IP, Wi-Fi, radio waves, etc.). The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

Short range communication, such as short range communication between any combination of the portable device 104, the first user device 106, and the second user device 108, may include any suitable mechanism such as Bluetooth ™, near-field communication (NFC), radio waves, or infrared. As further explained below, the transaction processing system may be used to advantageously provide alternative information flows or transaction flows when a contactless payment with the portable device cannot be processed in an automated or semi-automated fashion, which can avoid additional input from the second user to reinitiate or create a new transaction.

The first user 102 may operate the portable device 104 to initiate a transaction or as a part of a transaction flow at the second user device 108. The second user device 108 may be associated with or operated by the second user 110 and interact with the application server 112. For example, the second user device 108 may include an application and may be configured to communicate with the application server 112 in connection with services, goods, access, payment requests, or other information.

The second user device 108 may be a mobile device which may be incapable of being in electrical contact with a chip or other electrical contact point of a portable device 104. In some embodiments, the second user device 108 may also be incapable of accepting a secret from the first user 102, such as a PIN or passcode, which may necessitate the secret being entered on an alternative device such as the first user device 106. In some examples, the second user device 108 may contain software associated with a processing network or authorizing entity which prevents it from accepting secrets from a first user 102 due to security or other concerns.

The first user device 106 may be a mobile device operated by the first user. The first user device can comprise one or more applications related to the second user device, a payment processing provider, or an authorizing entity.

The portable device 104 can be, for example, a contactless payment card associated with first user 102. The portable device 108 can be configured to communicate with the second user device 108 and can provide interaction data to the second user device 108 via a short-range communication channel (e.g., Bluetooth, Bluetooth low energy (BLE), near-field communication (NFC), etc.).

The interaction processing server 114 can determine if an interaction between a portable device and a second user device can be used to complete a transaction.

The transport computer 116 may be associated with an acquirer or possibly an issuer of an account of a second user. The acquirer may issue and manage a financial account for the second user, e.g., associated with a second user account identifier.

The processing computer 118 may be associated with a payment processing network. A payment processing network may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. Furthermore, the payment processing network may use any suitable wired or wireless telecommunications network, including the Internet.

In some embodiments, the processing computer 118 may store tokens for a plurality of users in an token database (not shown), e.g., via a registration process. For example, one or more tokens for each user may be stored in the token database based on a device identifier and/or an account identifier (e.g., a primary account number (PAN)) associated with the user during an enrollment or registration process.

In some embodiments, the authorizing entity computer 120 may be associated with an issuer. An issuer can be any bank that can issue and maintain a financial account for a user, e.g., the first user 102.

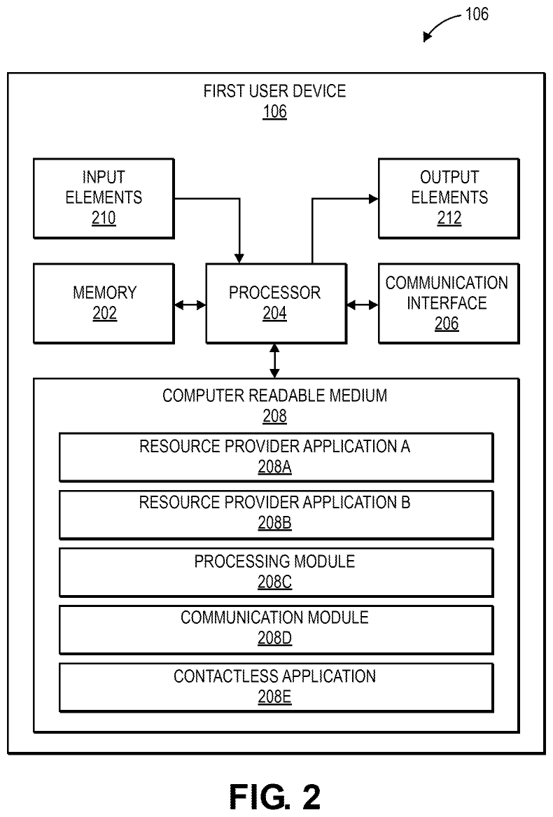

FIG. 2 shows a block diagram of the first user device 106 according to embodiments. The exemplary first user device 106 may comprise a processor 204. The processor 204 may be coupled to a memory 202, a communication interface 206, input elements 210, output elements 212, and a computer readable medium 208. The second user device 106 may also have programs that can allow it to interact with the second user 110 and/or the application server 112 to initiate transactions, record the outcomes of transactions, and display information related to transactions to the second user 110 or the first user 102.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device. For example, the memory 202 can store interaction data, application data, etc.

The one or more input elements 210 may include any suitable device(s) capable of inputting data into the first user device 106. Examples of input elements 210 include buttons, touchscreens, touch pads, microphones, cameras, etc.

The one or more output elements 212 may comprise any suitable device(s) that may output data. Examples of output elements 212 may include display screens, speakers, and data transmission devices. For example, the output elements 212 can include a display screen capable of displaying a response value to a user of the first user device 106.

The computer readable medium 208 may comprise several software applications and/or software modules. Examples of such modules can include a first resource provider application 208A, a second resource provider application 208B, a processing module 208C, a communication module 208D, and a contactless application 208E. The first and second resource provider applications 208A and 208B can be first and second merchant applications. The processing module 208C in conjunction with the processor 204 can cause the first user device 106 to process data for transactions. It may include a QR code application that can read and process QR codes, or similarly displayed codes (e.g., MaxiCodes, MS Tags, Blipper, Data Matrix) to initiate or further a transaction flow or interaction. It may also include a web payment processing program that can allow for the continued processing of a transaction session with a second user in the event that an initial transaction attempt is not successful. The communication module 208B and the processor 204 can perform processing to the first user device 106 to communicate with external entities. The contactless application 208E can be an application that facilitates “tap to pay” mechanisms, such as tapping a portable device to the first user device 106 to obtain credentials or tokens from the portable device.

The first user device 106 may be capable of reading a machine readable code such as a QR™ code. For example, the user 102 may scan a QR™ code associated with a transaction displayed on a display of the second user device 108 using a camera or a scanning device in the first user device 106. The QR™ code may include information (e.g., a resource provider identifier, a transaction amount, etc.) for a transaction conducted with the second user device 108. The first user device 104 may also allow the first user 102 to provide payment credentials for a transaction using link to a resource provider website (e.g., a merchant website).

In some embodiments, the first user device 106 may decode a machine readable code obtained from a second user device, and can display transaction details encoded by the machine readable code to the first user 102. After this, the first user device 106 may prompt the first user 102 to provide a credential or token to conduct a transaction such as a payment transaction.

The computer readable medium 208 may comprise code, executable by the processor 204, for performing steps associated with methods and flows described herein.

The communication interface 206 may include one or more devices and software that can allow the first user device 106 to communicate with external computers or devices. The communication interface 206 may enable the first user device 106 to communicate data to and from another device (e.g., a resource provider device, a resource provider server, a portable device, a device, computer, and/or server of a processing system, etc.). Some examples of the communication interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the communication interface 206 may include Wi-Fi™. Data transferred via the communication interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the communication interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium. The communication interface 206 may be associated with or operated in conjunction with communication API 208D.

The processing module 208C can be utilized by one or more resource provider applications 208A and 208B installed on the first user device 106 or the second user device 108 to process data.

In some embodiments, the processing module 208C can include a kernel-on-device (KoD) service. A KoD service can include a contactless entry point, contactless kernel(s), cardholder verification method (CVM) module(s), a payment card data encryption module, and/or other software modules that can be utilized for an interaction (e.g., a contactless payment transaction).

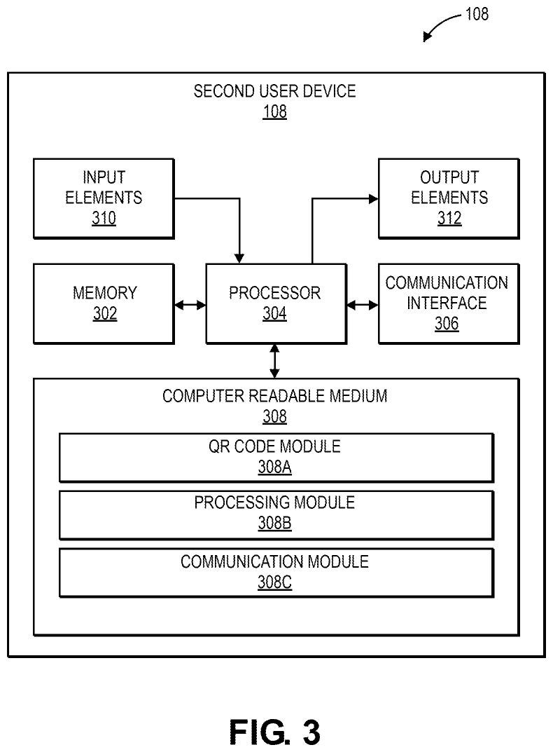

FIG. 3 shows a block diagram of the second user device 108 according to embodiments. The exemplary second user device 108 may comprise a processor 304. The processor 304 may be coupled to a memory 302, a communication interface 306, input elements 310, output elements 312, and a computer readable medium 308. Second user device 108 may also be unable to perform certain acts with respect to a payment card or portable device 104, such as being in physical and electrical communication with a circuit or integrated chip of the portable device 104.

The processor 304, the memory 302, the communication interface 306, the input elements 310, the output elements 312, and the computer readable medium 308 may be similar to the processor 204, the memory 202, the communication interface 306, the input elements 210, the output elements 212, and the computer readable medium 208 described above with reference to FIG. 2. The various components described with respect to FIG. 3 may be coupled or related to one another similar to the description provided above with reference to FIG. 2.

The computer readable medium 308 may comprise several software applications and/or software modules. Examples of such modules can include a QR code module 308A, a processing module 308B, and a communication module 308C. The computer readable medium 308 may also comprise code, executable by the processor 304 to perform a method comprising: prompting, a first user to interact a portable device of the first user with the second user device in a transaction; receiving interaction data comprising a credential or token, from the portable device in a contactless communication; determining that the transaction cannot be completed without further interaction by the first user; responsive to determining that the transaction cannot be completed, providing at least one alternate transaction option for the first user; receiving, from the first user, a selection of an alternate transaction option from the at least one alternate transaction option; and processing the transaction according to the selected alternate transaction option.

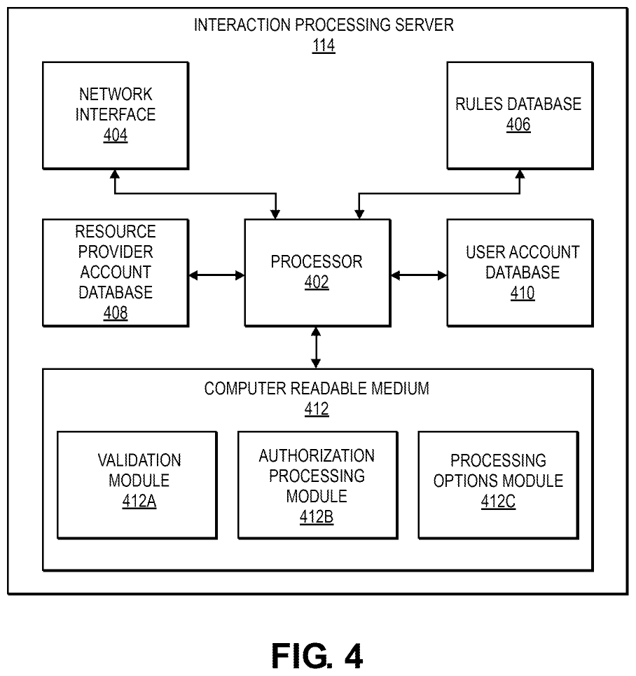

FIG. 4 illustrates some components of a interaction processing server 114 according to an embodiment. The interaction processing server 114 may include a processor 402 coupled to a network interface 404, a transaction rules database 406, a resource provider account database 408, a user account database 410 and a computer readable medium 412.

The computer readable medium 412 may comprise code executable by the processor 402 for implementing methods using embodiments of the invention. For example, the computer readable medium 412 can comprise code, executable by the processor 402 to perform operations comprising: receiving, by an interaction processing server from a second user device operated by a second user in a transaction between the second user and a first user, after the first user interacts a contactless portable device with the second user device, a payload comprising payload information comprising a credential or token, and transaction information; determining, by the interaction processing server, if the payload information can be used to complete the transaction; determining, by the interaction processing server that the payload information cannot be used to complete the transaction; and transmitting, by the interaction processing server, a response message to the second user device, wherein the second user device provides options for completing the transaction to the first user.

The computer readable medium 412 may include a validation module 412A, an authorization processing module 412B, and a processing options module 412C.

The rules database 406 may contain a set of rules to determine whether a transaction can be completed based on interaction data obtained from a portable device. The transaction rules database 406 may contain logic or rules to enable any of the behavior described herein, including without limitation, (i) a requirement that the portable device 104 must be in physical and electrical contact with the second user device, (ii) a requirement related to the total value of the transation, (iii) a cumulative value of transactions in a time period (e.g., a currency value over a number of hours, days, or weeks), (iv) the number of contactless or tap-to-pay transactions attempted within a time period, (v) the geographic location of the portable device at the time the transaction was attmepted, (vi) the geographic location of where the portable device 104 was issued, (vii) a geographic match or mismatch, or other geographical location information related to the portable device 104, the first user device 106, and the second user device 108. The transaction rules database may also contain criteria for the types of allowed transactions from the first user device 106 which may rectify the non-allowed transation. This information may be provided to the second user device 108 from the interaction processing server 114 via an indication which embeds this information. For instance, the indication may be that the transaction cannot be completed without additional information from the first user, such as entering his or her payment information or providing a PIN on the first user device 106.

In other examples, an authorizing entity may set conditions regarding the processing of a transaction based on an interaction and the additional requirements. To successfully process the transaction. For instance, the authorizing entity associated with the credential or token provided from the portable device 104 may require that the first user enter a secret, a passcode, a PIN, or may require physical or electrical contact between the portable device and the second user device.

Although not illustrated in FIG. 4., the interaction processing server may also include an authentication database, which may store one or more of voice, a passcode, a password, a personal identification number (PIN), a password, facial identification, etc. In some embodiments, the authentication data may be stored in the authentication database 406 at the time of the user registration. In some embodiments, the authentication data in the authentication database may be linked to the respective device identifiers and/or user account identifiers.

The resource provider account database 408 may be configured to store information associated with a plurality of resource accounts along with their account identifiers.

The user account database 410 may be configured to store information associated with a plurality of user accounts along with their account identifiers and user information (e.g., phone numbers, etc.) The validation module 412A can include code executable by the processor 402 for validating data in a payload from a second user device to determine if the data therein can be used to complete a transaction. The validation module 412A and the processor 402 can use the rules in the rules database 406 and apply them to the information in the payload to determine if the transaction can or cannot be successfully completed.

The authorizing processing module 412B and the processor 402 can generate and transmit authorization request messages, and receive and process authorization response messages for transactions.

The processing options module 412C can include options for completing transactions if initial attempts to compete transactions are not successful. The options may be processes that can be used to ensure that the type of second user device, credentials, tokens, or portable devices that were initially used to conduct transactions are completed.

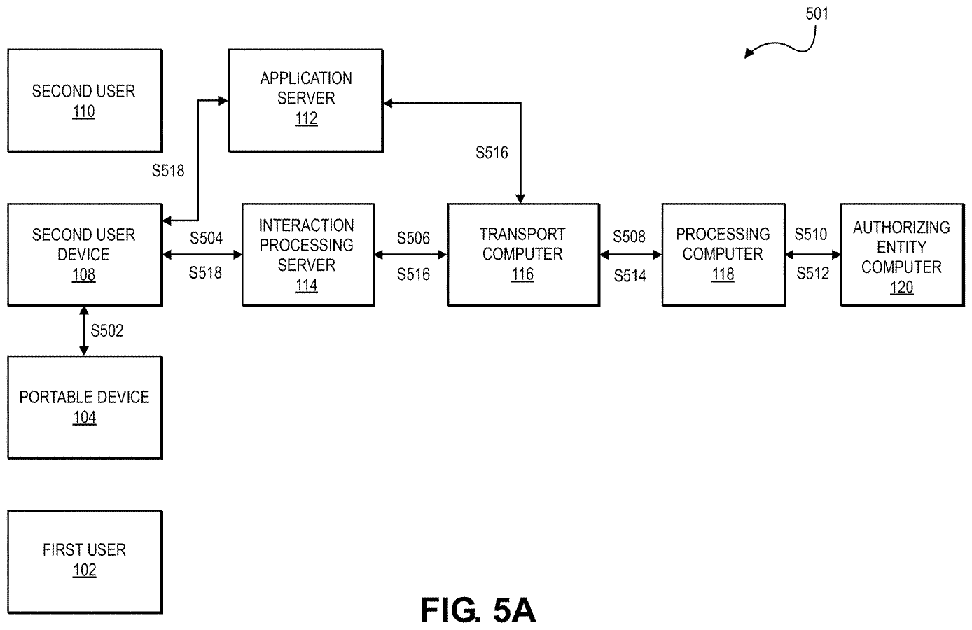

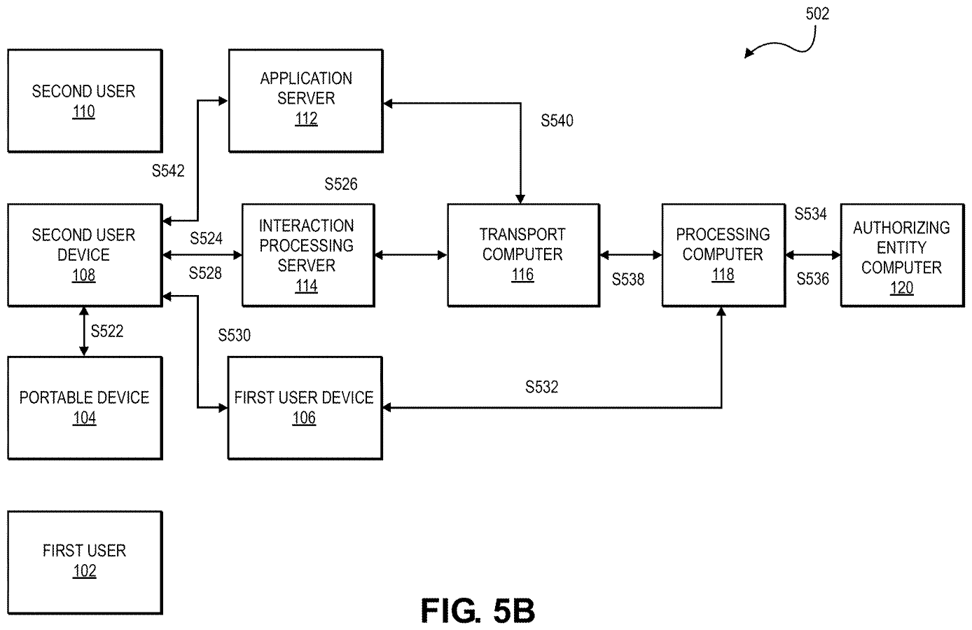

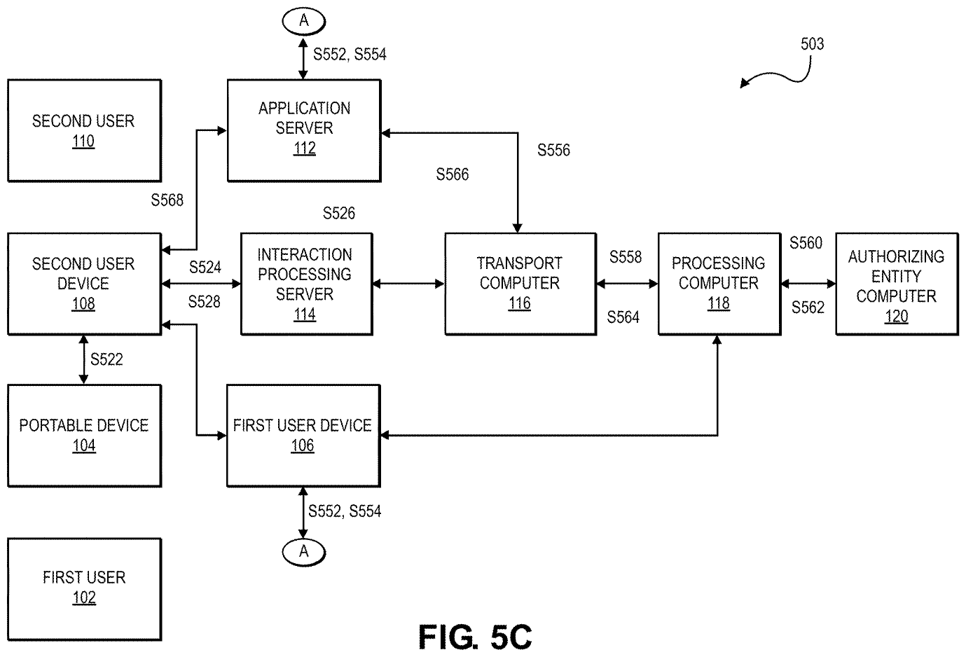

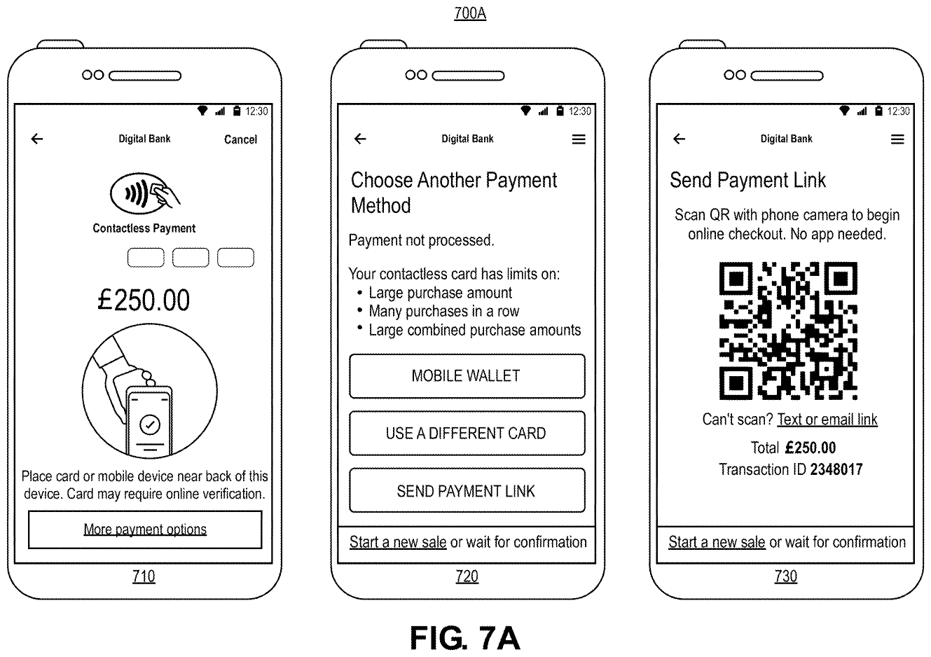

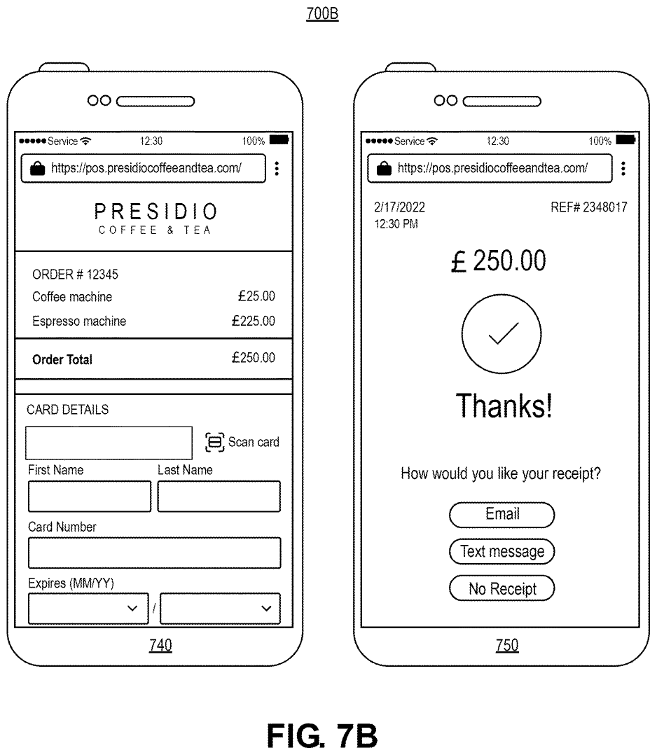

FIG. 5A illustrates a flow 501 illustrating a “tap to pay” process in which the first user 102 taps their portable device 104 to the second user device 108 to conduct a payment transaction and the payment transaction is successfully completed. Before step S502, the first user 102 may wish to pay the second user 110 in a transaction. For example, the transaction may be a payment transaction for a resource or may be a person-to-person funds transfer transaction. The second user device 108 can display a transaction amount for the transaction and this amount may be shown to the first user 102. An example of this is shown in user interface 710 in FIG. 7A.

At step S502, the first user 102 may interact (e.g., tap) their portable device 104 with the second user device 108. The portable device 104 may be a payment card such as a credit card, which can interact with the second user device 108 through a contactless communication. The portable device 104 can pass a payload including a payment credential or payment token to the second user device 108 from the portable device 104 through a short-range communication protocol such as NFC or Bluetooth™.

At step S504, the second user device 108 may transmit another payload with payload information to the interaction processing server 114, which may be remotely located with respect to the second user device 108. The payload information may contain information related to the transaction (e.g., the transaction amount and an identifier for the second user or the second user device 108) in addition to the credential or token that was received from the portable device 104.

After receiving the payload, the interaction processing server 114 can determine if the transaction should proceed based on at least the data in the payload. Various rules may be applied in the determination. For example, a rule may be that a transaction that conducted with a debit card requires a PIN to proceed and only certain mobile phones are secure enough to process PIN transactions. The interaction processing server 114 can determine if the second user device 108 satisfies this rule. Additionally, the interaction processing server 114 may to evaluate whether the interaction between portable device 104 and the second user device 108 is otherwise valid and that the received payload has sufficient information for the interaction processing server 114 to process the transaction. If the interaction processing server 114 determines that the transaction can proceed, it may generate an authorization request message comprising at least the transaction amount, an identifier of the second user of the second user device, and the credential or token.

At step S506, the interaction processing 114 server may transmit the authorization request message to the transport computer 116.

At step S508, the transport computer 116 may transmit the authorization request message to the processing computer 118.

At step S510, the processing computer 118 can analyze the credential or the token. If a token is present, then the processing computer 118 can detokenize the token to obtain the credential associated with the token. The processing computer 118 can have or be in communication with a token vault or token database which stores mappings between tokens and credentials (e.g., primary account numbers). The processing computer 118 can then replace the token with the credential in the authorization request message. Once the credential is obtained, the processing computer 118 can determine the authorizing entity computer 120 by analyzing the credential or other data. The processing computer 118 can then transmit the authorization request message to the authorizing entity computer 120.

At step S512, the authorizing entity computer 120 may determine if the transaction is authorized. The determination can be based upon whether the first user 102 has sufficient credit or funds in an account associated with the credential. It can also be based on a determination by the authorizing entity computer 120 that the transaction has a low likelihood of being fraudulent. The authorizing entity computer 120 can then generate an authorization response message comprising the authorization result. The authorization response message may include the credential, a transaction ID, a timestamp, an identifier for the second user 110 or the second user device 108, an approval or decline indicator, etc. After the authorization response message is generated, it is transmitted to the processing computer 118.

In step S514, if the original authorization request message included a token instead of a credential, then the processing computer 118 may substitute the token for the credential in the authorization response message. The authorization response message may then be sent to the transport computer 116. The transport computer 116 may optionally provide the authorization response message to the application server 112 which is associated with a second user application on the second user device 108.

In step S516, the transport computer 116 may route the authorization response message to the interaction processing server 114.

In step S518, the interaction processing server 114 or the application server 112 may send a confirmation message to the second user device 108. The second user device 108 may then display the confirmation message to the second user 110.

At the end of the day or any other suitable period of time, a clearing and settlement process can take place between the transport computer 116, the processing computer 118, and the authorizing entity computer 120.

FIG. 5B illustrates a transaction flow 502 according to embodiments of the invention. In this example transaction flow 502, the interaction processing server 114 can determine that the transaction cannot be completed using a contactless portable device and the second user device 108. It can then automatically provide options for the first user and the second user 102 to complete the transaction in a different way without abandoning the transaction.

At step S522, the first user 102 may interact (e.g., tap) their portable device 104 on the second user device 108. The portable device 104 may be a payment card such as a credit card, which can interact with the second user device 108 through a contactless communication. The portable device 104 can pass a payload including a payment credential or payment token to the second user device 108 from the portable device 104 through a short-range communication protocol such as NFC or Bluetooth™. An example of a screen that can be shown on the second user device 108 can be user interface 710 in FIG. 7A.

At step S524, the second user device 108 may transmit another payload with payload information to the interaction processing server 114, which may be remotely located with respect to the second user device 108. The payload information may contain information related to the transaction (e.g., the transaction amount and an identifier for the second user or the second user device 108) in addition to the credential or token that was received from the portable device 104.

After receiving the payload, at step S526, the interaction processing server 114 can determine if the transaction should proceed based on at least the data in the payload. As noted above, various rules may be applied in the determination. For example, a rule may be that a transaction that conducted with a debit card requires a PIN to proceed and only certain mobile phones are secure enough to process PIN transactions. The interaction processing server 114 can determine if the second user device 108 satisfies this rule. Additionally, the interaction processing server 114 may to evaluate whether the interaction between portable device 104 and the second user device 108 is otherwise valid and that the received payload has sufficient information for the interaction processing server 114 to process the transaction.

Other rules that may be applied by the interaction processing server 114 can include whether the transaction amount for the current transaction is below a threshold amount for which contactless payments are permitted, whether the second user device 108 has sufficient security features to secure conduct the transaction, etc. In some cases, historical data related to a user account associated with the portable device 104 or the first user 102 may be used to determine if the transaction can be completed. For example, the velocity limits (e.g., a maximum number or cumulative amount of transactions within a predetermined period of time) can be applied to transactions conducted using the portable device 104. Such rules and constraints may be provided to the interaction processing server 114 by an authorizing entity that issued the credential or token being used to conduct the transaction.

In step S528, the interaction processing server 114 may generate a response message and transmit it to the second user device 108. The response message can include an indication that the current transaction cannot be completed between the portable device 104 and the second user device 108, and that additional action on behalf of the first user 102 is required to complete the transaction. The response message may also optionally provide one or more options that can be used to complete the transaction if those options are not already programmed into the second user device 108. In some embodiments, the options that are presented may have been previously evaluated by the interaction processing server 114 and the interaction processing server 114 may have determined that the presented options (e.g., in the form of selectable buttons) can be used to successfully complete the transaction. In a first example option, the transaction can be completed using a machine readable code such as a QR code, which may be generated by the second user device 108. The machine readable code can be scanned by the first user device 106, which may complete the transaction. In a second example option, the first user 102 may select a button on the second user device 108 to send a link to the first user device 106. The link may direct the first user device 106 to the application server 112 associated with an application on the second user device 108. The first user 102 may then complete the transaction using the first user device 106. In a third example option, the first user 102 may be prompted to use a different portable device 104 to complete the transaction.

The above-noted first and second options can use the first user device 106 of the first user 102 to complete the transaction, instead of the second user device 108. One advantage of this is that the first user 102 can safely enter sensitive data into it, because it is held and operated by the first user 102. For example, entry of a PIN into the first user device 106 is less likely to raise fewer security concerns than entry of a PIN into the second user device 108 which is not held or owned by the first user 102. Thus, embodiments can improve transaction security by providing more secure payment options where initial attempts to conduct payment transactions are deemed unsecure.

Once second user device 108 receives the response message, the options for completing the transaction can be presented to the first user on the second user device 108. An example of a user interface is shown in 720 in FIG. 7A. The first user 102 can decide to complete the transaction using the first example option using a QR code. In response to this selection, the second user device 108 can generate a QR code including the transaction amount and an identifier for the entity that will receive the funds from first user 102, and a transaction identifier. The identifier could be an account identifier of an account of the second user 110 and/or a device identifier for the second device 108 or a second user identifier for the second user 110 (which may be linked to an account of the second user 110). An example of a user interface is shown in 730 in FIG. 7A.

At step S530, the first user device 106 may scan the QR code displayed on second user device 108 using a camera in the first user device 106. The first user device 106 can use an application or software to decode the QR code to obtain the information in the QR code. The first user device 106 can then generate a transaction message including at least some of the information in the QR code (e.g., a transaction amount, a transaction identifier, a second user device identifier, an account identifier for the second user, etc.), and the credential or token of the first user 102. In some embodiments, the credential or token can be obtained from the first user device 106 if this information is stored in it. This can be the case if the first user device 106 is a mobile phone with a digital wallet. In another embodiment, the first user device 106 can receive the credential or token from the portable device 104 via a contactless communication such as an NFC communication.

At step S532, the first user device 106 may send the transaction message to the processing computer 118.

In step S534, the processing computer 118 can then generate appropriate transaction request message(s) to complete the transaction and can transmit the same to the authorizing entity computer 120 and/or the transport computer 116 in steps S536 and S538. After the transport computer S526 is notified of the authorization of the transaction, it can provide a notification to the application server in step S540, which can in turn notify the second user device 108 in step S542.

In some embodiments, an AFT (Account funding Transaction) message may be generated by the processing computer 118 and transmitted to the authorizing entity computer 120 to debit the account of the first user 102. An OCT message could then be generated and sent to an entity (e.g., an acquirer or issuer) that operates the transport computer 116 to credit an account of the second user 110.

An AFT (Account Funding Transaction) is a transaction designed to supply funds to another account such as a credit, prepaid, debit, ATM or on-line account. In some embodiments, the AFT message can be used to pay a service provider for sending funds to the recipient and results in a debit to the sender's account. The amount of the debit can be the amount of the credit to be delivered to the recipient plus any fees being charged by the service provider such as a transfer fee, or a currency conversion fee (if applicable).

An AFT indicator can be used in both the authorization and clearing and settlement transactions and is preceded by an authorization. Settlement can take place within two working days, or more or less than this. Neither the authorization nor the clearing transaction carries any financial information about the recipient of a money transfer. In some embodiments, the AFT carries the account number or other identifier associated with the payment account of the sender. An AFT message can also be accompanied by indicators, which allow the sender's issuer to take appropriate authorization decisions. Indicators include channel information such as Mail Order/Telephone Order or Internet, etc.

The following fields can be used for an AFT and can be supported in messages and clearing and settlement transactions. The fields included in a traditional AFT message can include, but is not limited to an account number, a processing code; merchant type; CAVV result code; Mail Order/Telephone Order/Electronic Commerce Indicator; Mail/Phone/Electronic Commerce Indicator; transaction ID (XID); etc.

An OCT (Original Credit Transaction) is typically a clearing and settlement credit transaction designed for use in business applications such as a business money transfer or business-to-consumer repayments. In embodiments of the invention, the OCT can be used to deliver funds to the recipient account. It can be separate from, and can take place after, the AFT transaction. This timing can ensure that payment funds are secured before funds are sent to the recipient.

The amount of the OCT can be the amount agreed to by the sender and the service provider in the currency agreed. The OCT can carry the account number of the recipient and no information about the sender. A special indicator can identify an OCT to the recipient's issuer bank. Settlement can take place within two days, or more or less time than this.

In other embodiments, the processing computer 118 may generate an authorization request message 118 including the transaction amount, the identifier for the second user or the second user device, and the credential (or token). The authorization request message may then be transmitted to the authorizing entity computer 120 for authorization.

The authorization entity computer 120 can then transmit an authorization response message to the transport computer via the processing network computer 118 as described above with respect to the process in FIG. 5A. Upon receipt of the authorization response message, the processing computer 118 can transmit a notification of a successful transaction to the first user device 106.

At the end of the day or any other suitable period of time, a clearing and settlement process can take place between the transport computer 116, the processing computer 118, and the authorizing entity computer 120.

Although in the above embodiments, the processing computer 118 receives a transaction message from the first user device 106, and the processing computer 118 generates the appropriate messages to complete the transaction, in other embodiments, another entity such as the application server 112, the interaction processing server 114, the transport computer 116, and the authorizing entity computer 112 could receive the message with the transaction information from the first user device 106 to complete the transaction.

Advantageously, in the process flow 502, the transaction between the first user and the second user was successfully completed, even though the initiation of the transaction was not successful. Embodiments can save an a transaction that would otherwise be abandoned, thus conserving computing resources.

FIG. 5C illustrates a transaction flow 503 illustrating an example process flow for the above noted second option that sends a link to the first user device 106 to complete a transaction that the interaction processing server determined was not capable of being completed by the portable device 104 and the second user device 108. The link can be a payment link that can be delivered to the first user device 106 in any suitable manner (e.g., a text message or e-mail).

In flow 503, steps S522, S524, S526, and S528 are described above with respect to FIG. 5B, and the descriptions thereof are incorporated herein. However, in the second option, the first user 102 selects the option to receive a link such as a payment link to complete the transaction. The first user 102 may select a button on the second user device 108 to selection this second option. The first user 102 may enter a phone number, e-mail address, or other identifier to receive the link. Alternatively, the link may be encoded within a QR code, which can be scanned by the first user device 106. The first user device 106 can decode the QR code to obtain the link.

At step S550, the second user device 108 may send a message to the application server 112 with an instruction to send the link to the identifier entered by the first user 102. The identifier may be a phone number, and the application server in response can send a text message comprising the link to the first user device 106 in step S552.

Upon receiving the link, the first user device 106 can display the link to the first user 102 (e.g., a text message application). The first user 102 can then select the link and may be re-directed to the application server 112. Once the first user device 106 is in communication with the application server 112, the application server can generate a checkout page or other funds transfer page with the information about the transaction and can request that the first user 102 provide a payment credential or token to complete the transaction in step S554. As noted in the other examples, the first user device 106 can then obtain the credential or token from memory or can obtain it from the portable device 104 and provide this information to the application server 112. The first user 102 can also manually enter the credential or token into the first user device 106. An example of a user interface is shown in 740 in FIG. 7B. The application server 112 can then generate an authorization request message with the transaction amount and the credential or token, and can transmit it to the transport computer 116.

At step S558, the transport computer 116 may transmit the authorization request message to the processing computer 118.

At step S560, the processing computer 118 can analyze the credential or the token. If a token is present, then the processing computer 118 can detokenize the token to obtain the credential associated with the token. The processing computer 118 can have or be in communication with a token vault or token database which stores mappings between tokens and credentials (e.g., primary account numbers). The processing computer 118 can then replace the token with the credential in the authorization request message. Once the credential is obtained, the processing computer 118 can determine the authorizing entity computer 120 by analyzing the credential or other data. The processing computer 118 can then transmit the authorization request message to the authorizing entity computer 120.

At step S562, the authorizing entity computer 120 may determine if the transaction is authorized. The determination can be based upon whether the first user 102 has sufficient credit or funds in an account associated with the credential. It can also be based on a determination by the authorizing entity computer 120 that the transaction has a low likelihood of being fraudulent. The authorizing entity computer 120 can then generate an authorization response message comprising the authorization result. The authorization response message may include the credential, a transaction ID, a timestamp, an identifier for the second user 110 or the second user device 108, an approval or decline indicator, etc. After the authorization response message is generated, it is transmitted to the processing computer 118.

In step S564, if the original authorization request message included a token instead of a credential, then the processing computer 118 may substitute the token for the credential in the authorization response message. The authorization response message may then be sent to the transport computer 116. The transport computer 116 may optionally provide the authorization response message to the application server 112 which is associated with a second user application on the second user device 108.

In step S566, the transport computer 116 may route the authorization response message to the iapplication server 122.

In step S568, the application server 112 may send a confirmation message to the second user device 108. The second user device 108 may then display the confirmation message to the second user 110.

Upon receipt of the authorization response message, the application server 112 (or other entity that is aware of the approved authorization response message) can transmit a notification of a successful transaction to the first user device 106.

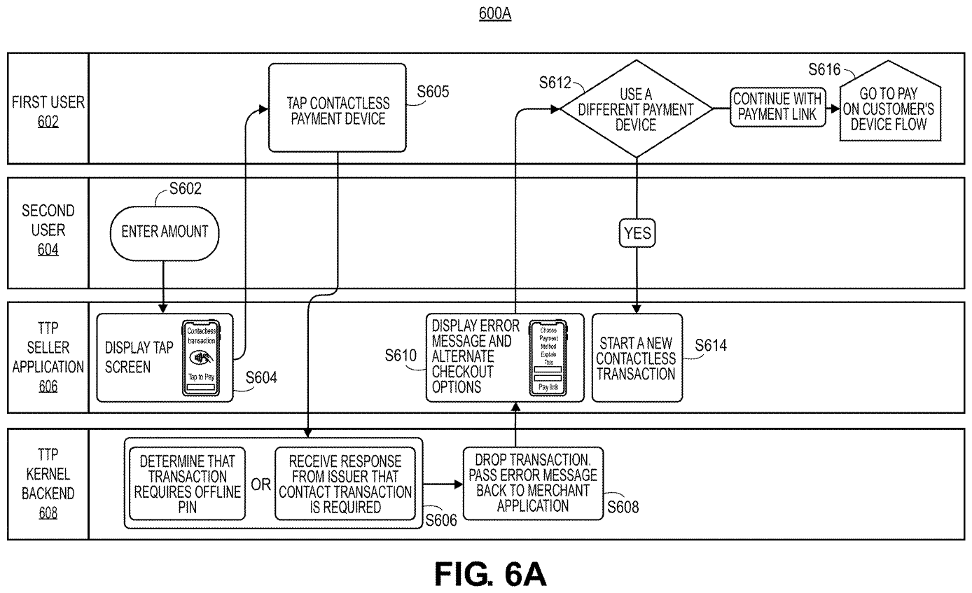

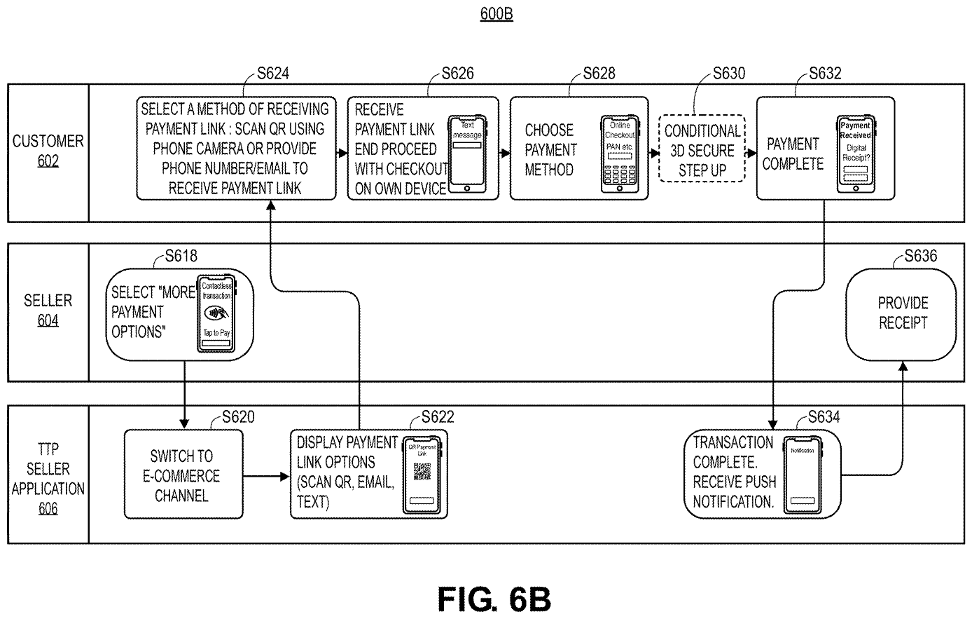

FIGS. 6A and 6B show flow diagrams representing a transaction flow of performing a payment transaction according to other embodiments. A first user 102 may choose to perform the payment transaction with a second user 604 for a good and/or service. The second user 604 can use a tap to pay (TTP) seller application 106 in the second user device. The first user 602 can use a payment device (e.g., digital wallet, credit card, etc.) to perform the payment transaction with the second user 604 via the second user device. The second user device can be a mobile phone. During the payment transaction, the second user device of the second user 604 can be in communication with TTP kernel backend 608 to validate the payment device.

In step S602, the second user 604 can enter a transaction amount in the TTP application 606. In step S604, the TTP application 606 can display a tap to pay screen where the first user 602 can perform the payment transaction by interacting the second user device (which has the TTP application 606) with the payment device that supports the contactless payments. The payment device that supports the contactless payments can include a mobile wallet (e.g., tap-to-phone), contactless credit card (e.g., a tap-to-pay credit card), etc. An exemplary tap-to-pay screen can be shown in screen 710 of FIG. 7A. In some embodiments, the TTP application 606 can invoke a contactless kernel from the TTP kernel backend to prepare for a contactless payment transaction.

In step S605, the first user 602 can interact (e.g., via tapping) the payment device with the second user device that has the TTP application 606. Upon tapping, the contactless payment device can send payment credential of the payment device to the TTP kernel backend 608. The payment credential can include credit card number, name, expiration date, CVV, etc.

In step S606, the TTP kernel backend 608, upon receiving the payment credential, can review the payment credential. The TTP kernel backend can determine that the transaction requires an offline PIN or can receive a response from an issuer of the payment device that contact transaction is required. The issuer may also require a contact transaction if the payment device has a transactional limit, further card holder verification (CVM) of the first user 602 is needed, etc.

In some embodiments, the TTP kernel backend 608 may accept the payment device, send an authorization request to the issuer, and receive an authorization response from the issuer of a successful payment transaction. The TTP kernel backend 608 can then notify the TTP application 606 of the successful payment transaction, where the TTP application 606 can display transaction approval status and ask if the first user 602 wants a receipt. If the first user 602 desires the receipt, then the second user 604 can provide receipt to the first user 602.

In step S608, the TTP kernel backend 608 can drop the payment transaction and pass error message of a failed transaction back to the TTP application 606.

In step S610, the TTP application 606, upon receiving the error message from the TTP kernel backend 608, can determine that the transaction cannot be processed. The TTP application 606 can display the error message and can provide alternate checkout options. The alternate checkout options may be offering the first user 602 to use a different payment device (e.g., digital wallet, contactless credit card, etc.) or an option of using a payment link or machine readable code to continue the payment transaction. An exemplary alternative payment screen can be shown in screen 720 of FIG. 7A.

In step S612, the first user 602 can select an option among different alternate payout options. In step S614, the first user 602 can select an option among to use a different payment device. Upon selecting to use the different payment device, the TTP application 606 can start a new contactless transaction with a tap-to-pay screen similar to the screen 710 of FIG. 7A. In step S616, the first user 602 can select an option to use a payment link to perform a payment transaction.

In some embodiments, the first user 602 may not have a payment device that can perform a contactless transaction from the start. In such case, the second user 604 or the first user 602 can choose alternative payment options from the start of the payment transaction in step S618 in FIG. 6B. In step S620, the TTP application 606 can be directed to the alternative payment options that can be shown in screen 720 of FIG. 7A. The first user 602 can select an option to use a payment link to perform a payment transaction similar to step S616.

In step S622, the first user device can display a payment link screen. The payment link screen can be shown in screen 730 of FIG. 7A. The payment link can be transmitted to a first user device of the first user, or may be embedded in a QR code, which can be scanned by the first user device to obtain the payment link.

In step S624, the first user 602 can select an option or method to receive the link.

In step S626, the first user 602 can receive the payment link (i.e., checkout page) and can launch a checkout page. The checkout page screen can be shown in screen 740 of FIG. 7B In step S628, the first user 602 can input payment credential in the checkout page. Once the first user 602 finishes inputting the payment credential in the checkout page, the customer can select an option to send the payment credential to the TTP kernel backend 608 (not shown). In some embodiments, the payment link may require a conditional authentication (e.g., 3D Secure) step up (step S630) before sending the payment credential. In step S632, the payment credential may be sent to the TTP kernel backend 608 and the payment may be completed.

In step S634, the TTP application 606 may receive a notification from the TTP kernel backend 608 of the completed transaction. The TTP application 606 may launch transaction complete screen with an option to provide a receipt. The payment complete screen can be shown in screen 750 of FIG. 7B. In step S636, if the first user 602 selects to receive the receipt, the second user 604 can provide the receipt to the first user 602 using the TTP seller application 606 via email or text message.

Embodiments of the invention have a number of teaching advantages. As explained above, a transaction that that cannot be initially completed can be completed using embodiments of the invention. Information initially generated for a transaction by a second user device is not lost and can be repurposed so that the transaction can be completed in a secure and efficient manner. Without embodiments of the invention, transactions that cannot be initially completed cannot be completed at all. New transactions would need to be initiated, thereby unnecessarily consuming computing resources. Further, embodiments of the invention can automatically detect if transactions to be conducted are not secure, and can provide more secure payment processing to complete transactions that could otherwise not be completed.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
prompting, by a second user device operated by a second user, a first user to interact a portable device of the first user with the second user device in a transaction;
receiving, by the second user device, interaction data comprising a credential or token, from the portable device in a contactless communication;
determining, by the second user device, that the transaction cannot be completed without further interaction by the first user;
responsive to determining that the transaction cannot be completed, providing, by the second user device, at least one alternate transaction option for the first user;
receiving, by the second user device from the first user, a selection of an alternate transaction option from the at least one alternate transaction option; and
processing, by the second user device, the transaction according to the selected alternate transaction option.

2. The method of claim 1, wherein, processing the transaction according to the selected alternate transaction option comprises:
displaying a QR code encoding transaction information, and then allowing a first user device to obtain an image of the QR code and to process the transaction according to the transaction information and the credential or the token.

3. The method of claim 2, wherein the portable device is a card.

4. The method of claim 2, wherein the contactless communication is an NFC communication.

5. The method of claim 2, wherein the first user device is a first mobile phone, the second user device is a second mobile phone, and the portable device is a card.

6. The method of claim 1, wherein, processing the transaction according to the selected alternate transaction option comprises:
a process for providing a link to a first user device of the first user device, wherein the link directs the first user device to an application server, which allows the first user to complete the transaction.

7. The method of claim 1, wherein determining, by the first user device, that the transaction cannot be completed without further interaction by the first user, is based on a requirement that a secret of the first user is required to be entered into the second device, but the second device is incapable of processing the secret.

8. The method of claim 1, wherein determining, by the first user device, that the transaction cannot be completed without further interaction by the first user, is based on a requirement that an authorizing entity associated with the credential or token requires that the first user device be in contact with the second user device to conduct the transaction, but the first user device and the second user device are incapable of being on physical and electrical contact with each other.

9. The method of claim 1, wherein the determination that the transaction cannot be completed is based on a total value of the transaction.

10. The method of claim 1, wherein determining, by the second user device, that the transaction cannot be completed without further interaction by the first user comprises determining that the second user device is not sufficiently secure to complete the transaction.

11. The method of claim 10, wherein the at least one alternate transaction option is more secure than a transaction process conducted with the second user device.

12. The method of claim 1, further comprising:
transmitting, by the second user device to an interaction processing server, a payload comprising payload information comprising the credential or token, and transaction information, which determines that the transaction cannot be completed without further interaction by the first user and generates a message indicating that the transaction cannot be completed without further interaction, and wherein the second user device determines that transaction cannot be completed without further interaction after receiving the message.

13. The method of claim 12, wherein the interaction processing server comprises a rules database with rules that are used to make determination that the transaction cannot be completed without further interaction.

14. The method of claim 1, wherein the second user device receives the token.

15. The method of claim 1, wherein the second user device receives the credential.

16. The method of claim 15, wherein the credential is an account identifier for an account of the first user.

17. A second user device comprising:
a processor; and
a non-transitory computer readable medium, the non-transitory computer readable medium comprising code, executable by the processor, for performing operations comprising:
prompting, a first user to interact a portable device of the first user with the second user device in a transaction,
receiving interaction data comprising a credential or token, from the portable device in a contactless communication,
determining that the transaction cannot be completed without further interaction by the first user,
responsive to determining that the transaction cannot be completed, providing at least one alternate transaction option for the first user,
receiving, from the first user, a selection of an alternate transaction option from the at least one alternate transaction option, and
processing the transaction according to the selected alternate transaction option.

18. A method comprising:
receiving, by an interaction processing server from a second user device operated by a second user in a transaction between the second user and a first user, after the first user interacts a contactless portable device with the second user device, a payload comprising payload information comprising a credential or token, and transaction information;
determining, by the interaction processing server, if the payload information can be used to complete the transaction;
determining, by the interaction processing server that the payload information cannot be used to complete the transaction; and
transmitting, by the interaction processing server, a response message to the second user device, wherein the second user device provides options for completing the transaction to the first user.

19. The method of claim 18, wherein the options include the generation of a QR code encoding the transaction information, which can be scanned by a first user device operated by the first user to complete the transaction.

20. The method of claim 18, wherein the options include a transmission of a link to a first user device, which can be used by the first user to complete the transaction.
